(19) United States
(12) Patent Application Publication
(10) Pub. No.: US 2011/0148048 A1
(43) Pub. Date: Jun. 23, 2011

(54) SEALING ARRANGEMENT

(75) Inventors: Goetz GROSSER, Dresden (DE); Hans-Juergen HEINRICH, Grossroehrsdorf (DE); Harald GRUNE, Dresden (DE)

(73) Assignee: VON ARDENNE ANLAGENTECHNIK GMBH, Dresden (DE)

(21) Appl. No.: 12/971,001

(22) Filed: Dec. 17, 2010

(30) Foreign Application Priority Data
Dec. 18, 2009 (DE) 10 2009 059 099.4
Apr. 14, 2010 (DE) 10 2010 027 757.6

(51) Int. Cl. F16J 15/02

(52) U.S. Cl. 277/628

(57) ABSTRACT

A sealing arrangement for a feedthrough is located between a first machine element and a second machine element and comprises a first sealing element, and a second sealing element disposed in the axial direction of the first machine element at a distance from the first sealing element. The inner sides of the sealing elements form a sealing operative connection with the first machine element. An intermediate space between the first sealing element and the second sealing element is divided into a first chamber and a second chamber connected to each other by an annular gap between the first machine element and the sealing arrangement. The first chamber includes an inlet for a rinsing medium and the second chamber includes a first outlet for drainage or suction of the rinsing medium and possible leakages.

### CROSS REFERENCE TO RELATED APPLICATIONS

This application claims priority of German application DE 10 2009 059 099.4 filed on Dec. 18, 2009 and German application DE 10 2010 027 757.6 filed on Apr. 14, 2010, the entire contents of both of these applications being hereby incorporated by reference herein.

### BACKGROUND ART

The invention relates to a sealing arrangement that can be used for static seals, but also for rotary feedthroughs such as those used in vacuum-processing facilities by way of example. Sealing arrangements of this type are described in DE 10 2009 014 214, for example.

Rotary feedthroughs are needed in order to guide rotating parts such as shafts through housing walls and the like when the driving machine element, e.g. a drive arrangement, is disposed on one side of the housing wall and the machine element to be driven, e.g. a rotating target, is disposed on the other side of the housing wall. By contrast, static feedthroughs serve for guiding stationary components through housing walls.

If a pressure differential must be maintained between the two sides of the housing wall (for example, atmospheric pressure on one side, high vacuum on the other side) and/or the atmospheres on the two sides of the housing wall have different compositions (for example, air on one side, inert gas on the other side), then it is necessary to configure the rotary feedthrough so as to prevent undesirable equalization of pressure or an exchange of gas between the two sides of the housing wall due to leakage in the rotary feedthrough.

Static or rotary feedthroughs for vacuum facilities can, for example, comprise two seals acting in tandem, where one seal is disposed such that it has a sealing effect relative to the atmosphere or the vacuum and the other seal is disposed such that it has a sealing effect relative to the vacuum or the process atmosphere or any other medium, for example, a cooling medium. A complete separation of the media can be achieved between these two seals, for example, by means of a sealing medium, that is, a sealing gas or a sealing liquid. Alternatively, a separation of the atmosphere and a processing space can be achieved by means of an intermediate vacuum generated between both seals.

Feedthroughs, the task of which is to securely separate incompatible media from each other, are generally in the form of two-stage or multi-stage feedthroughs. In order to detect harmful wear and tear of the seals ahead of time, leak-monitoring systems are often used. In some embodiments, electronic wear marks are used that detect the degree of wear. In other solutions, the leakage is measured quantitatively by sensors disposed between the sealing lips.

In place of wear detection, other solutions suggest the use of active sealing media that do not harm any of the two media to be separated. It is also known that some solutions used in coolant seals cause the intermediate space to be dried out by blowing out the leak. One result of the blowing-out process, in part, is that, for example, coolant can also travel toward the other sealing lip as a result of the leak. In the case of a leak in the sealing lip, the second medium becomes contaminated.

### BRIEF SUMMARY OF THE INVENTION

It is an object of the invention to enable an early detection of the risk of leakage in the sealing lip disposed on the medium side by means of a simple construction of the sealing system and to prevent, as far as possible, the leakage of the first medium from wetting the second sealing lip.

According to the invention, this object is achieved such that the sealing combination is provided with two sealing lips. The intermediate space between the two sealing lips is divided into two chambers that are connected to each other by a common annular gap. For controlling leaks, a rinsing medium propels any leaking coolant entering by way of the annular gap through bores.

For purposes of the invention, an annular gap is a region that closely surrounds the first machine element and is large enough to prevent the sealing arrangement from colliding with the first machine element, but at the same time wide enough to allow a rinsing medium such as water or air to pass through. By contrast, the chambers that are separated by the annular gap and that likewise surround the first machine element have a clearly larger diameter in order to be able to receive a selectable volume of rinsing medium.

The invention therefore suggests a sealing arrangement for a feedthrough for receiving a first machine element, the outer side of which sealing arrangement can be attached to a second machine element, which sealing arrangement comprises a first sealing element and a second sealing element disposed in the axial direction of the first machine element at a distance from the first sealing element, the inner sides of which sealing elements are designed for forming a sealing operative connection with the first machine element, the intermediate space between the first sealing element and the second sealing element being divided into a first chamber and a second chamber, which chambers are connected to each other by means of an annular gap between the first machine element and the sealing arrangement, and the first chamber comprising an inlet for a rinsing medium and the second chamber comprising a first outlet for the drainage or suction of the rinsing medium and possible leakages.

The sealing elements can be attached, for example, to a base body that is in the form of a rotary part and the outer side of which can be attached to a second machine element, for example, an equipment housing or the wall of a vacuum chamber, in that the base body is flange-mounted thereon or inserted into a bore or any other opening intended for the same and fixed therein, for which purpose additional sealing elements can be provided on the outer side of the base body. Furthermore, the base body can be configured such that its inner side comprises a circumferential rib that forms the annular gap in cooperation with the first machine element.

In a development of the invention, a third sealing element is provided that is disposed in the axial direction of the first machine element at a distance from the first sealing element, the intermediate space between the first sealing element and the third sealing element comprising an outlet for the drainage or suction of the rinsing medium and possible leakages. This third chamber comprising the associated outlet for suction once again improves the sealing effect of the sealing arrangement considerably.

The inlet for the rinsing medium and/or the first outlet and/or the second outlet for drainage or suction can each be guided from the outside toward the inside through the sealing arrangement into the first chamber. This embodiment can be advantageous particularly for rotating first machine elements in order to simplify the supply and removal of media.

The inlet for the rinsing medium and/or the first outlet and/or the second outlet for drainage or suction can each also be guided from the inside toward the outside through the first machine element into the first chamber. This embodiment can be advantageous particularly for rotating first machine elements, when the supply and removal of media are intended to be carried out from the vacuum side, or for stationary first machine elements.

The sealing arrangement suggested herein is suitable, for example, for a rotary feedthrough that is loaded by coolant pressure and that is intended to protect a space located on the atmosphere side from leakage by means of two rotary seals.

In a further embodiment, the pressure of the rinsing medium can be monitored constantly in order to detect a failure of the first sealing element. For this purpose, the sealing arrangement can be in operative connection with a monitoring arrangement.

Provision can also be made in a further embodiment to maintain the pressure of the rinsing medium proportional to the pressure of the coolant in order to achieve an optimum sealing behavior of the second sealing element. For this purpose, the sealing arrangement can be in operative connection with a control arrangement.

Since the sealing principle is mainly based on the separation of two incompatible media, its application to a vacuum chamber cannot be equated with other applications. Here, it must be observed that it can be meaningful to provide an additional outlet for suction before the vacuum seal—as described above—in order to meet increasing vacuum requirements.

### BRIEF DESCRIPTION OF THE DRAWING FIGURES

The invention is explained below in more detail with reference to exemplary embodiments and associated drawings, in which:

FIG. 1 shows a first exemplary embodiment;

FIG. 2 shows a second exemplary embodiment;

FIG. 3 shows a third exemplary embodiment; and

FIG. 4 shows a fourth exemplary embodiment.

### DETAILED DESCRIPTION

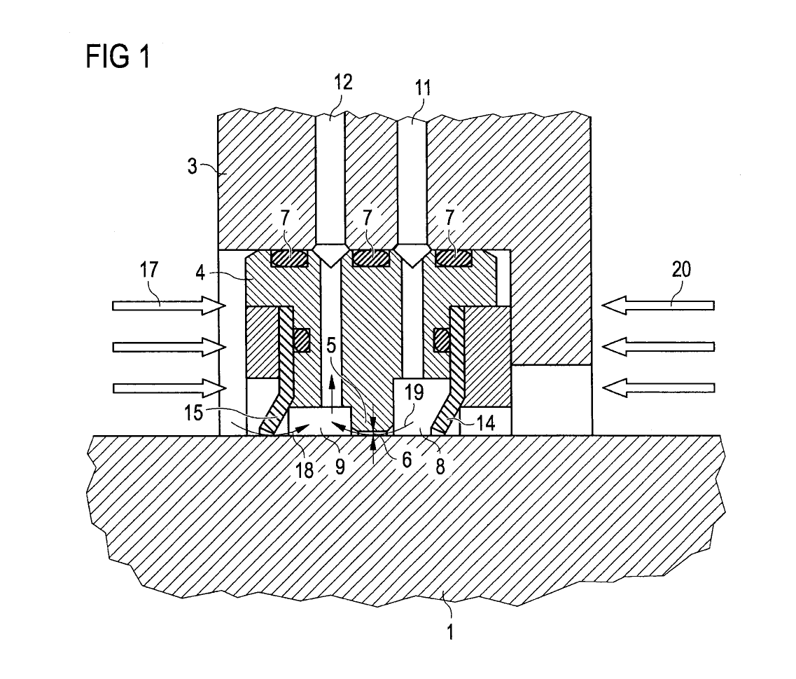

In the exemplary embodiments shown in FIGS. 1 to 3, the sealing arrangement comprises a separate base body 4 that is sealed by outer sealing elements 7 in relation to the second machine element 3.

On this base body 4, there is disposed a first sealing element 14 and a second sealing element 15 that form a sealing connection with the first machine element 1, for example, a shaft. The first sealing element 14 separates the rinsing medium 19 (e.g. dry compressed air) from the atmosphere 20. The second sealing element 15 separates coolant 17 from the rinsing medium 19.

The base body 4 comprises a circumferential rib 5 that has an inside diameter that is slightly larger than the outside diameter of the shaft 1 so that an annular gap 6 is formed. Advantageously, the annular gap 6 is disposed around the circumference of the shaft 1; however, other arrangements of the annular gap 6 are also possible as explained in more detail below in the description of the individual figures. For example, a circumferential shoulder 2 of larger diameter can be disposed on the shaft 1, which shoulder forms an annular gap 6 with the base body 4 or a circumferential rib 5 of the base body 4, or a circumferential rib 5 of the base body 4 engages with a circumferential groove of the shaft 1. In the latter case, the base body 4 can, for example, be bipartite in order to enable assembly and disassembly.

For example, the sealing arrangement can be sealed by means of outer sealing elements 7 (O-rings) disposed statically in the second machine element 3 that can be a housing, for example.

The coolant 17 present under pressure creates an unavoidable coolant leakage 18 on the second sealing element 15. Dry compressed air that is subjected to a pressure that is lower than the pressure of the coolant 17 is blown into the inlet 11 for the rinsing medium 19 in order to prevent the second sealing element 15 from being lifted. The dry compressed air 19 flows by means of bores that can be distributed uniformly on the circumference of the base body into the first chamber 8 between the first sealing element 14 and the annular gap 6. Dry compressed air 19 flowing through the narrow annular gap 6 prevents the leaking coolant 18 from penetrating the atmosphere-side first sealing element 14. The dry compressed air 19 flows through the annular gap 6 out of the first chamber 8 into the second chamber 9. The annular gap 6 is kept very narrow so that the dry compressed air 19 attains high flow speed.

Due to the strong flow of dry air 19, the leaking coolant 18 is immediately transported out of the annular gap 6 by way of bores toward the first outlet 12 and to the leak-monitoring system. The quantitative assessment of the leak is carried out according to known methods outside of the rotary feedthrough shown. A measurement and evaluation of humidity is carried out in the case of media such as coolant 18 and dry air 19.

In principle, this solution can be used for all combinations, in which rinsing medium 19 and coolant 18 can be mixed and the rinsing medium 19 is noncritical to the atmosphere side 20. In the case of inflammable coolants 18, it is feasible to use nitrogen or oxygen-reduced air as the rinsing medium 19.

The figures show different embodiments of the sealing arrangement described.

FIG. 1: A first machine element 1 (shaft) is mounted for rotation in a sealing arrangement that comprises a base body 4 and is disposed, for its part, in a second machine element 3 (housing). The sealing arrangement comprises a base body 4 (ring) comprising two sealing lips 14, 15. These sealing lips 14, 15 are in contact with the surface of the first machine element 1. From the inner side of the housing 3, a coolant 17 bears in pressurized form against the second sealing lip 15. From the outer side of the housing 3, atmospheric pressure 20 bears against the first sealing lip 14.

Bores serving as an inlet 11 for a rinsing medium 19 and as a first outlet 12 for the drainage of the rinsing medium 19 pass through the housing 3 toward the ring 4. These bores open out into additional bores that are placed in the ring 4 and that serve for guiding the rinsing medium 19 into a first chamber 8 or to drain possible leakages of the coolant 18 from the second chamber 9. The bores in the ring 4 extend in the radial direction and are distributed over the circumference of the ring 4. Channels that distribute the rinsing medium 19 from the bore disposed in the housing 3 (inlet) to the radial bores of the ring 4 or that collect rinsing medium 19 and leaking coolant 18 from the radial bores of the ring 4 and guides the same into the bore disposed in the housing 3 (outlet) extend on the outer side of the ring 4 around the circumference thereof.

The first chamber 8 and the second chamber 9 are connected to each other by an annular gap 6, through which the rinsing medium 19 travels from the first chamber 8 into the second chamber 9, and which simultaneously prevents leaking coolant 18 from entering the first chamber 8 from the second chamber 9.

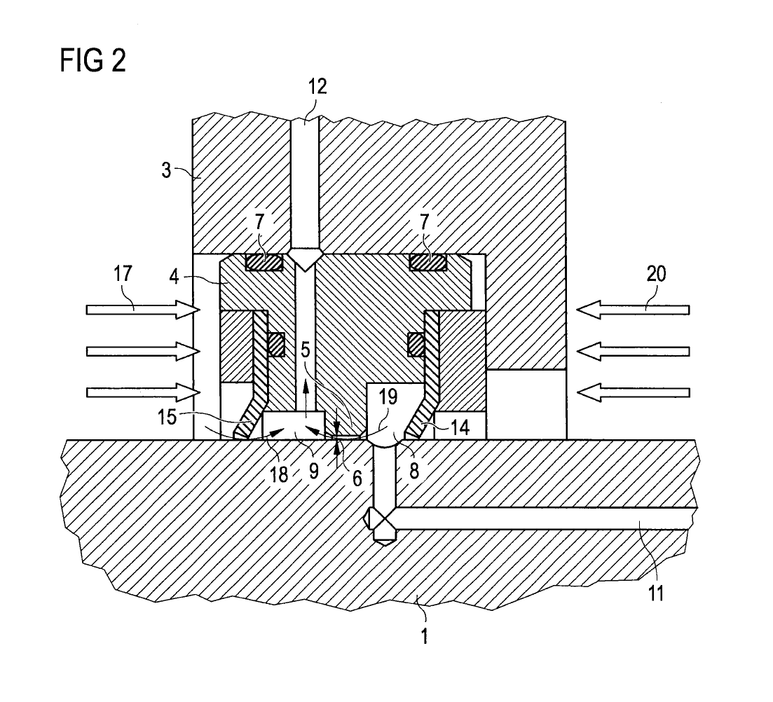

FIG. 2: This embodiment differs from the embodiment shown in FIG. 1 in that the inlet 11 for the rinsing medium 19 is not guided through the second machine element 3 (housing) and the base body 4 (ring) into the first chamber 8, but instead this inlet 11 is realized by means of bores in the first machine element 1 (shaft). An axially extending bore guides the rinsing medium 19 into the region of the first chamber 8. A plurality of bores that are distributed over the circumference of the shaft 1 extend from this axial bore in the radial direction and open out into the surface of the shaft 1 in the region of the first chamber 8.

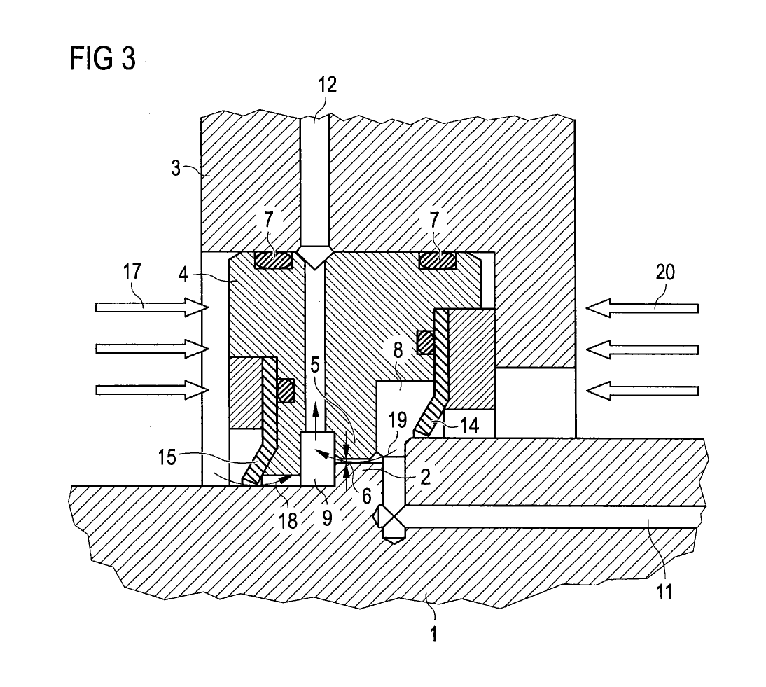

FIG. 3: This embodiment differs from the embodiment shown in FIG. 2 in that the shaft 1 comprises a shoulder 2 in the region of the sealing arrangement and the sealing lips 14, 15 therefore have different inside diameters. The shoulder 2 again makes it difficult for leaking coolant to enter the first chamber 8 from the second chamber 9.

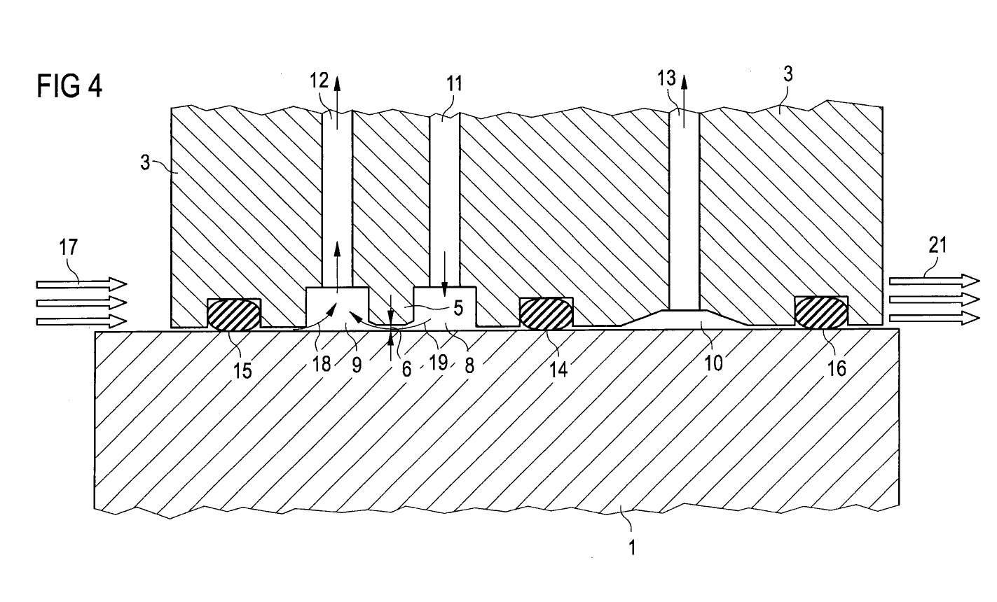

FIG. 4: This embodiment is a static feedthrough, in which the first machine element 1 is stationary relative to the second machine element 3. In place of sealing lips, O-rings are used as sealing elements 14, 15, 16 in this exemplary embodiment; however, sealing lips can also be used here as in the other exemplary embodiments. The sealing arrangement in this embodiment does not comprise a separate base body 4; rather, the components of the sealing arrangement are directly integrated into the second machine element 3.

In this exemplary embodiment, the pressure of the coolant 17 acting from one side of the sealing arrangement must be sealed off from the high vacuum 21 acting on the other side of the sealing arrangement.

Three sealing elements 14, 15, 16 (O-Rings) are disposed in tandem. The space between the second O-ring 15 oriented toward the interior of the housing 3 and the central first O-ring 14 is in turn divided into a first chamber 8 and a second chamber 9, both of which are connected to each other by an annular gap 6. The space between the central O-Ring 14 and the third O-ring 16 oriented toward the outer side of the housing 3 comprises a second outlet 13 for an intermediate suction connection or a fore-vacuum.

1. A sealing arrangement for a feedthrough, the sealing arrangement being located between a first machine element and a second machine element and comprising a first sealing element, and a second sealing element disposed in an axial direction of the first machine element at a distance from the first sealing element, inner sides of both sealing elements forming a sealing operative connection with the first machine element, an intermediate space between the first sealing element and the second sealing element being divided into a first chamber and a second chamber connected to each other by an annular gap between the first machine element and the sealing arrangement, and the first chamber comprising an inlet for a rinsing medium and the second chamber comprising a first outlet for drainage or suction of the rinsing medium and possible leakages.

2. The sealing arrangement as defined in claim 1, further comprising a third sealing element disposed in the axial direction of the first machine element at a distance from the first sealing element, an intermediate space between the first sealing element and the third sealing element comprising a third chamber and a second outlet for the drainage or suction of the rinsing medium and possible leakages.

3. The sealing arrangement as defined in claim 1, wherein the inlet for the rinsing medium is guided from an inside toward an outside through the first machine element into the first chamber.

4. The sealing arrangement as defined in claim 1, wherein the inlet for the rinsing medium is guided from an outside toward an inside through the sealing arrangement into the first chamber.

5. The sealing arrangement as defined in claim 1, wherein the first outlet for drainage or suction is guided from an inside toward an outside through the first machine element into the second chamber.

6. The sealing arrangement as defined in claim 1, wherein the first outlet for drainage or suction is guided from an outside toward an inside through the sealing arrangement into the second chamber.

7. The sealing arrangement as defined in claim 2, wherein the second outlet for drainage or suction is guided from an inside toward an outside through the first machine element into the third chamber.

8. The sealing arrangement as defined in claim 2, wherein the second outlet for drainage or suction is guided from an outside toward an inside through the sealing arrangement into the third chamber.
